(19) United States
(12) Patent Application Publication
(10) Pub. No.: US 2009/0305723 A1
(43) Pub. Date: Dec. 10, 2009

(54) DETERMINATION OF LOCATION DEPENDENT INFORMATION

(76) Inventors: Kristan Barraclough, Hampshire (GB); Thomas Malcolm Chapman, Southampton (GB)

Correspondence Address: STAAS & HALSEY LLP, SUITE 700, 1201 NEW YORK AVENUE, N.W., WASHINGTON, DC, 20005, US

(21) Appl. No.: 12/448,469

(22) PCT Filed: Nov. 27, 2007
(86) PCT No.: PCT/GB2007/050718

§ 371 Date: Aug. 21, 2009

(30) Foreign Application Priority Data
Dec. 21, 2006 (GB) 0625502.0

(51) Int. Cl. H04W 24/00

(52) U.S. Cl. 455/456.1

(57) ABSTRACT

A method of determining position dependent information from one or more terminals in a cell involves transmitting at least two messages; wherein one message covers a first area in the cell; and one or more further messages cover other areas in the cell; and receiving responses from terminals dependent upon the messages received by each terminal; wherein the areas of coverage of the at least two messages at least partially overlap.

### CROSS REFERENCE TO RELATED APPLICATIONS

This application is based on and hereby claims priority to PCT Application No. PCT/GB2007/050718 filed on Nov. 27, 2007 and GB Application No. 0625502.0 filed on Dec. 21, 2006, the contents of which are hereby incorporated by reference.

### BACKGROUND OF THE INVENTION

This invention relates to a method of determining location dependent information from one or more terminals in a cell.

For mobile operators, spectrum efficiency is a key driver in evolution of network capabilities. In multimedia broadcast multicast service (MBMS), spectral efficiency may be increased in some circumstances if the positions (which is measurable as the pathloss to and/or angles of arrival) of terminals are known to the network through, for example, power control or beamforming Examples of such circumstances include situations where terminals or user equipments (UEs) are relatively sparsely located, or are concentrated into a certain area of a cell, such as to cover a car park or railway station, within a macrocell. However, there is currently no way to estimate terminal positions in the sense referred to above.

In Release 6 wideband code division multiple access (WCDMA), the only feedback for MBMS terminals that is defined in idle mode or CELL_FACH state is counting. Counting cannot be used to determine terminal position, in terms of pathloss, or angle of arrival (AoA), which is needed for improving spectral efficiency. Furthermore, in WCDMA, the probability factors that control the response to the counting procedure are sent on the MBMS control channel (MCCH), which is split into so called “critical” and “non-critical” information.

The existence of time multiplexed critical information reduces the rate at which the probability factors can be updated. Since prior to counting, the number and positions of terminals are unknown, there may be a need to understand UE placements and include counting in particular areas. In this situation it would be possible to limit the area for counting and then not use the probability factors (in the MCCH signal) to control the response rate as counting progresses. Therefore, the MCCH can be simplified to only include the critical information and this can be repeated at a required rate within a modification period.

### SUMMARY

The inventors propose a method of determining position dependent information from one or more terminals in a cell, which involves transmitting at least two messages; wherein one message covers a first area in the cell; and one or more further messages cover other areas in the cell; and receiving responses from terminals dependent upon the total number of messages received by each terminal; wherein areas of at least two of the messages partially overlap.

The proposed method obtains information on terminal location by providing at least two messages, such as instructions for a terminal to perform a function, such as cell reselection or handover, or counting indication messages of which at least one message is transmitted over a coverage area that is a subset of that of another of the message coverage areas, so that when the UEs receive these indicators, they respond accordingly.

Preferably, one message has a coverage area which is larger than the other and the one or more other coverage areas fall within the larger one.

The order in which the messages are sent is not restricted, but preferably, the second and subsequent messages are transmitted at a higher power than the first message, since it is advantageous to start with a lower power transmission covering a smaller area to avoid unwanted interference.

The other messages may be transmitted using the same antenna configuration, but a higher power level compared to the message sent to the smaller cell area.

Preferably, the one of the messages requires all the terminals to respond and other messages will prevent transmission of a response from those terminals which receive the other messages.

Preferably, the responses identify a location area within which the terminal resides.

In one embodiment, the message is a counting indication message and the response is a counting response. Alternatively, the message is a cell reselection or handover command.

The message may be sent to particular UEs within a cell range, using the proposed method, for the purpose of implementing a function either with, or without counting first.

Preferably, the location of the, or each other message is controlled by beamforming.

The other message may be transmitted using beamforming over a restricted portion of a cell, whereas the first message is transmitted over the whole cell.

Preferably, the beamforming beam is scanned across the cell to define subsequent other areas.

The beam may be moved around the cell in order to obtain a profile of UEs across the cell.

Preferably, all of the messages are transmitted simultaneously.

Preferably, the messages are hierarchically modulated.

Hierarchical modulation may be employed for signalling multiple messages with differing coverage levels.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 illustrates how critical and non-critical data is typically transmitted on the MCCH;

FIG. 2a illustrates a first example of determining position dependent information according to the proposed method;

FIG. 2b illustrates a second example of determining position dependent information according to the proposed method;

FIG. 2c illustrates an example of determining position dependent information according to the proposed method using scanned beamforming; and,

FIG. 3 illustrates use of hierarchical modulation in the proposed method.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

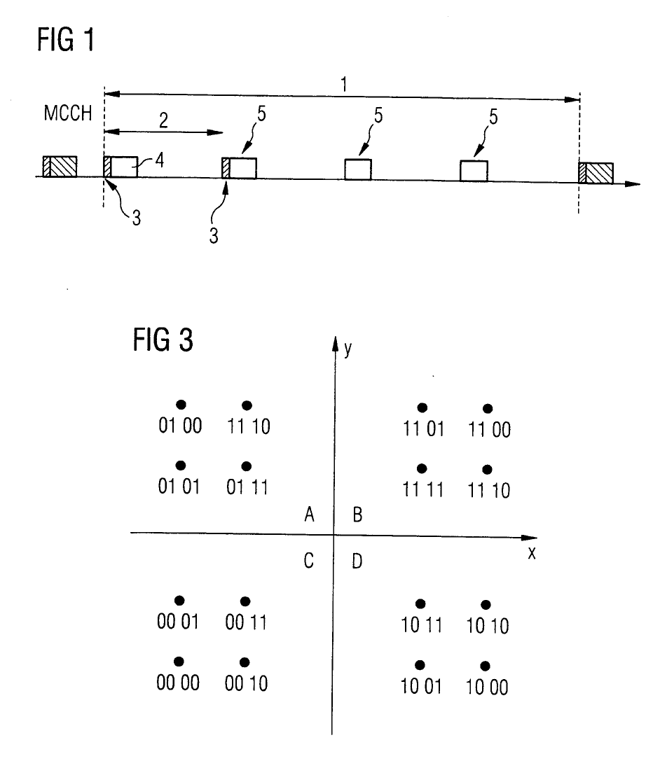

FIG. 1 shows how the MCCH transmits critical and non-critical data. Within a modification period 1, there is an initial access information period 2 during which a data block, split into MCCH non-critical data 3 and MCCH critical data 4, is transmitted. This block is repeated after the end of the access information period 2 and copied critical MCCH data 5 is sent in the remainder of the modification period 1.

In the proposed method, a series of at least two signals indicating a function to be performed by UEs on the cell edge, or counting are transmitted to UEs from an enhanced Node B (eNB). These signals have different coverage areas, so that UEs receive a combination of the signals dependent on their position. The UEs respond according to the number of messages from the sequence they receive within an allotted time. When the eNB receives the responses from each UE, the eNB can derive the position of the UE.

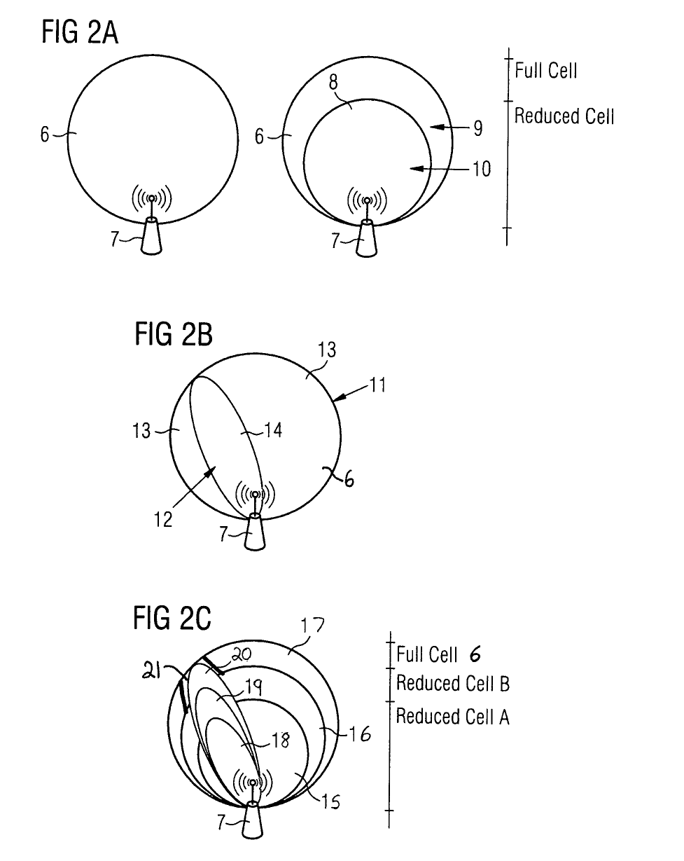

A first example is shown in FIG. 2a. Terminals in a cell 6 receive transmissions from a base station or Node B 7. To locate UEs within a more limited area of the cell, a reduced cell 8 is defined. In this example, two messages, e.g. counting signals, or function messages, are transmitted, the first message 9 of which covers the whole cell area 6 and the second message 10 of which is transmitted with a reduced power and hence covers only the area of the reduced cell 8, or vice versa. Alternatively, this could be done for two reduced cell areas of differing coverage, rather than the full cell and a reduced cell, as long as one is a subset of the coverage of the other. Terminals that receive the first message request 9, but not the second message request 10 respond. Such terminals are located near to the edge of the cell, in the area between the coverage of the first signal and that of the second. Alternatively, the first message may be sent to the reduced cell area and then subsequent messages are sent over the larger areas, so that the terminals are aware, in the smaller cell area, that they should not respond to the second message. This can be expanded to three or more areas by the use of successively increasing or decreasing power levels to form larger or smaller cell areas, or by “banded” areas, or cell portions arising from beamforming.

FIG. 2b illustrates the use of beamforming to produce a reduced cell area. A first message 11 is transmitted to the whole cell, but instead of simply reducing the power for a second message 12, as was done in the example of FIG. 2a, the transmitted beam is shaped to cover a designated area 14 to which the message 12 is sent, leaving the remainder 13 of the cell area 6 outside the beam where UEs receive only one message 11. To further subdivide the cell 6, the beam can be scanned across the cell and the messages adapted accordingly, so that responses from UEs to the base station are limited to a sufficiently small number that they do not cause interference with other traffic. If a sufficient series of power bands is used, then a low number of responses may be expected for some bands, particularly the outer ones. Thus, instead of using probability factors, the network can control the size of the counting bands to control the response rate. The use of power reduction and beamforming can be combined to obtain other coverage patterns in which a response is transmitted. This is shown in FIG. 2c. The sub-areas 14, 15, 16 will receive different messages. For example, in area 14 “do not respond”, in area 15 “do respond, but only to one message” and in area 16 “do respond”, so that the mid section 15 and the further section 16 can respond at separate times without further messages. Alternatively, there can be a response for areas 15, 16 without area 14.

The sequence of counting messages for each of the cell area 6 and the reduced cell areas 10, 14 may be transmitted simultaneously using hierarchical modulation. Each message occupies a different level of the constellation. For example, with two messages, the first message with full coverage is transmitted using the first modulation level in the hierarchy and the second message at the next level.

Hierarchical modulation allows signalling of two messages with different coverage. In FIG. 3, UEs with poor SNR receive the first 2 bits of the 4 bit message, indicated by the quadrant in which the signal is located, whereas UEs with higher SNR are able to resolve the sub-modulation points and receive all 4 bits. In this way, signalling to achieve the proposed idea does not necessarily represent an additional overhead. The modulation pattern can be adapted to suit different areas by changing the spacing of the constellation and the amount of points within the carrier.

In the example of FIG. 3, UEs with poor SNR are able to detect the quadrant of the signalling constellation within which the transmitted signal is located but are not able to resolve which of the 4 constellation points within the quadrant were transmitted. UEs with high SNR can also resolve the modulation point. If the modulation points are moved closer together, then the SNR required for unambiguously detecting the constellation point increases. Thus, for a UE with poor SNR, it may be able to determine that the signal is located within quadrant D, but not which of the four points within that quadrant. With good SNR, the UE may determine that the signal is at quadrant A, point 0100.

This method enables the network to obtain information on the position of terminals within the cell area in a cost-efficient manner. This is particularly important where large cells are considered; as might be the case with single frequency network (SFN), or in a hierarchical network where lower level cells are allowed to re-use MBMS resources where there are no MBMS terminals, given a reduction in interference from the MBMS. Alternatively, where MBMS multicast point to multipoint (ptm) is used to provide coverage for a clustered group of UEs using, for example beamforming, then point to point (ptp) links can be used for any odd additional UEs which are not within the main clustering area and hence the directed beam. If beamforming is used in addition, then a smaller number of UEs respond and the UE pathloss or AoA can be predicted with even more accuracy.

This method can also send a check message to one of the size cells so that using it in the case of two cell areas, where one wants to communicate to UEs further away, then a third message can be sent to the UEs closer or further away so that this can be used as a check message to double check that UEs further away receive the two messages but not the one at the reduced size. Alternatively the check message can be used for terminals closer so that UEs which receive both of the closer messages definitely do not respond and it is UEs which receive only the one further message which do respond.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-12. (canceled)

13. A method of determining position dependent information from one or more terminals in a cell, the method comprising:
transmitting at least two messages from a base station to terminals in the cell, one message covering a first area in the cell and one or more other messages covering at least another area in the cell, the areas of coverage of the at least two messages at least partially overlapping; and
receiving responses from the terminals dependent upon the messages received by each terminal.

14. The method according to claim 13, wherein one message has a coverage area which is larger than at least one other coverage area, the at least one other coverage area falling within the larger coverage area.

15. The method according to claim 14, wherein the message to be transmitted to the larger coverage area will be transmitted at a higher power than the one or more other messages.

16. The method according to claim 13, wherein one of the messages requires all the terminals to respond and the one or more other messages prevent transmission of a response from those terminals which receive the one or more other messages.

17. The method according to claim 13, wherein the responses identify a location area within which each of the terminals resides by indicating which sequence of messages the terminal received.

18. The method according to claim 13, wherein the messages are counting indication messages and the responses are counting responses.

19. The method according to claim 13, wherein a location of the one message or each of the one or more other messages is controlled by beamforming.

20. The method according to claim 19, wherein the beamforming beam is scanned across the cell to define subsequent other areas in the cell.

21. The method according to claim 13, wherein all of the messages are transmitted simultaneously.

22. The method according to claim 13, wherein the messages are hierarchically modulated.

23. The method according to claim 13, wherein the messages are cell reselection or handover messages.

24. A method according to claim 14, wherein the coverage areas includes at least two of a full area of the cell, a reduced sub-area of the cell, a beamformed sub-area of the cell, or a section of the cell defined by a combination of the other areas and the sub-areas.

25. A base station, comprising:
a transmitter transmitting at least two messages to terminals in a cell of the base station, one message covering a first area in the cell and one or more other messages covering at least another area in the cell, the areas of coverage of the at least two messages at least partially overlapping; and
a receiver receiving responses from the terminals dependent upon the messages received by each terminal.
